(19) United States
(12) Patent Application Publication
(10) Pub. No.: US 2018/0103063 A1
(43) Pub. Date: Apr. 12, 2018

(54) SECURITY ACCESS

(71) Applicants: Brent William Thurgood, Spanish Fork, UT (US); Daniel Sanders, Orem, UT (US); Polina Alber, Newton, MA (US)

(72) Inventors: Brent William Thurgood, Spanish Fork, UT (US); Daniel Sanders, Orem, UT (US); Polina Alber, Newton, MA (US)

(21) Appl. No.: 15/287,826

(22) Filed: Oct. 7, 2016

(51) Int. Cl. H04L 29/06; G06F 21/60

(52) U.S. Cl. CPC H04L 63/20; G06F 21/604; H04L 63/102

(57) ABSTRACT

A sample set of security accounts and a security permissions profile are obtained. Similarity index values are calculated for the accounts. The values are compared against a threshold range and identified as accounts that are certified for access review and as outliers that require additional access review.

### BACKGROUND

Network and computer security are of paramount concern in the industry today. It seems as if a week does not go by without some news about a network system being compromised. Moreover, this is not just private industry as governmental agencies experience security breaches with as much frequency as the private sector.

Companies are always adjusting network security systems and techniques to stay ahead of ever-changing external and internal breach attempts. In addition, governmental regulations concerning privacy and access to company information and assets create a tremendous amount of overhead, which any security adjustments have to account for.

Still further, an average company may have thousands of authorized user accounts providing varying levels of access to that company's assets. Companies have to manage each of these accounts to ensure against unauthorized access and ensure that governmental compliance is being maintained.

Many companies perform access reviews on their network accounts for enforcing a principle of least privilege, which means that users are only being granted access to resources that they need and that they have been granted legitimate access to. These reviews may need to be performed based on: any changes made to existing network security techniques, government compliance requirements, specific reported security violations, normal internal auditing, etc.

However, even with an average or small-sized company, the burden of performing access reviews can be a tremendous undertaking on staff and network computing resources because of the number of accounts and access permissions/restrictions embedded in the security systems.

### SUMMARY

Various embodiments of the invention provide methods and a system for identifying and performing security access reviews. In an embodiment, a method for processing a security access review is presented.

Specifically, in an embodiment, security permissions are obtained for principal accounts associated with principals. A security permissions profile is identified and a value for each principal account is generated based on the security permissions for that principal account and the security permission profile. Finally, select principal accounts are separated out for security access review based on the generated values for the select principal accounts.

### BRIEF DESCRIPTION OF THE DRAWINGS

FIG. 1A is a diagram depicting a group of user accounts in a security system with noted visually distinctive similarity and differences between the accounts in terms of account attributes, according an example embodiment.

FIG. 1B is a diagram depicting a formula for determining similarities between account attributes of user accounts, according to an example embodiment.

FIG. 1C is a diagram illustrating application of a given similarity profile for account attributes to identify similarity between user accounts, according to an example embodiment.

FIG. 1D is a diagram a graph that illustrates similarities and differences between user accounts using a similarity profile, according to an example embodiment.

FIG. 1E is a diagram of a graph that illustrates similarities and differences between user accounts using a different similarity profile from that of the FIG. 1D, according to an example embodiment.

FIG. 1F is a diagram depicting a group of user accounts in which each similar user in a group is compared against other users in the group based on a specific account attribute, according to an example embodiment.

FIG. 1G is a diagram depicting a graphical illustration of he similarity matrix, according to an example embodiment.

FIG. 1H is a diagram depicting a system for practicing security access review, according to an example embodiment.

FIG. 2 is a diagram of a method for processing a security access review, according to an example embodiment.

FIG. 3 is a diagram of another method for processing a security access review, according to an example embodiment.

FIG. 4 is a diagram of another security access review system, according to an embodiment.

### DETAILED DESCRIPTION

A “resource” includes: a user, service, system, a hardware device, a virtual device, directory, data store, groups of users, files, combinations and/or collections of these things, etc. A “principal” is a specific type of resource, such as an automated service or user that at one time or another is an actor on another principal or another type of resource. A designation as to what is a resource and what is a principal can change depending upon the context of any given network transaction. Thus, if one resource attempts to access another resource, the actor of the transaction may be viewed as a principal. Resources can acquire and be associated with unique identities to identify unique resources during network transactions.

An “identity” is something that is formulated from one or more identifiers and secrets that provide a statement of roles and/or permissions that the identity has in relation to resources. An “identifier” is information, which may be private and permits an identity to be formed, and some portions of an identifier may be public information, such as a user identifier, name, etc. Some examples of identifiers include social security number (SSN), user identifier and password pair, account number, retina scan, fingerprint, face scan, Media Access Control (MAC) address, Internet Protocol (IP) address, device serial number, etc.

A “processing environment” defines a set of cooperating computing resources, such as machines (processor and memory-enabled devices), storage, software libraries, software systems, etc. that form a logical computing infrastructure. A “logical computing infrastructure” means that computing resources can be geographically distributed across a network, such as the Internet. So, one computing resource at network site X can be logically combined with another computing resource at network site Y to form a logical processing environment. Moreover, a processing environment can be layered on top of a hardware set of resources (hardware processors, storage, memory, etc.) as a Virtual Machine (VM) or a virtual processing environment.

The phrases “processing environment,” “cloud processing environment,” “hardware processing environment,” and the terms “cloud” and “VM” may be used interchangeably and synonymously herein.

Moreover, it is noted that a “cloud” refers to a logical and/or physical processing environment as discussed above.

A “service” as used herein is an application or software module that is implemented in a non-transitory computer-readable storage medium or in hardware memory as executable instructions that are executed by one or more hardware processors within one or more different processing environments. The executable instructions programmed in memory when executed by the hardware processors. A “service” can also be a collection of cooperating sub-services, such collection referred to as a “system.”

A single service can execute as multiple different instances of a same service over a network.

Various embodiments of this invention can be implemented as enhancements within existing network architectures and network-enabled devices.

Also, any software presented herein is implemented in (and reside within) hardware machines, such as hardware processor(s) or hardware processor-enabled devices (having hardware processors). These machines are configured and programmed to specifically perform the processing of the methods and system presented herein. Moreover, the methods and system are implemented and reside within a non-transitory computer-readable storage media or memory as executable instructions that are processed on the machines (processors) configured to perform the methods.

Of course, the embodiments of the invention can be implemented in a variety of architectural platforms, devices, operating and server systems, and/or applications. Any particular architectural layout or implementation presented herein is provided for purposes of illustration and comprehension of particular embodiments only and is not intended to limit other embodiments of the invention presented herein and below.

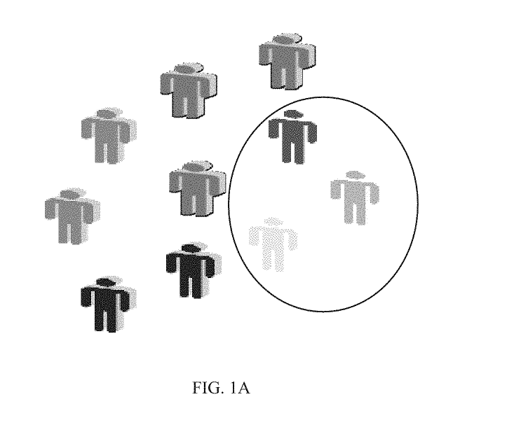

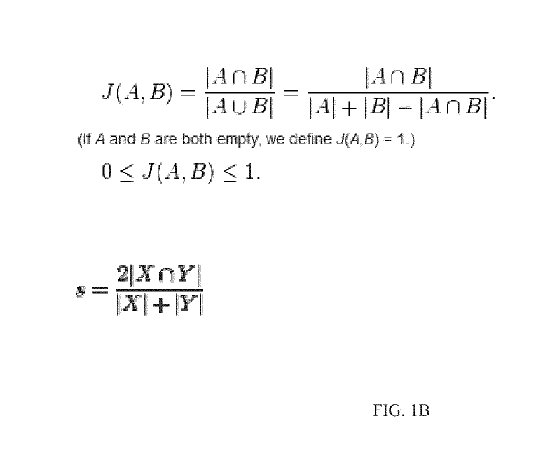

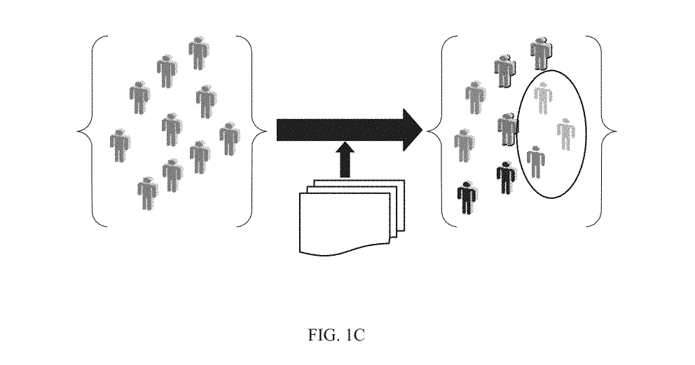

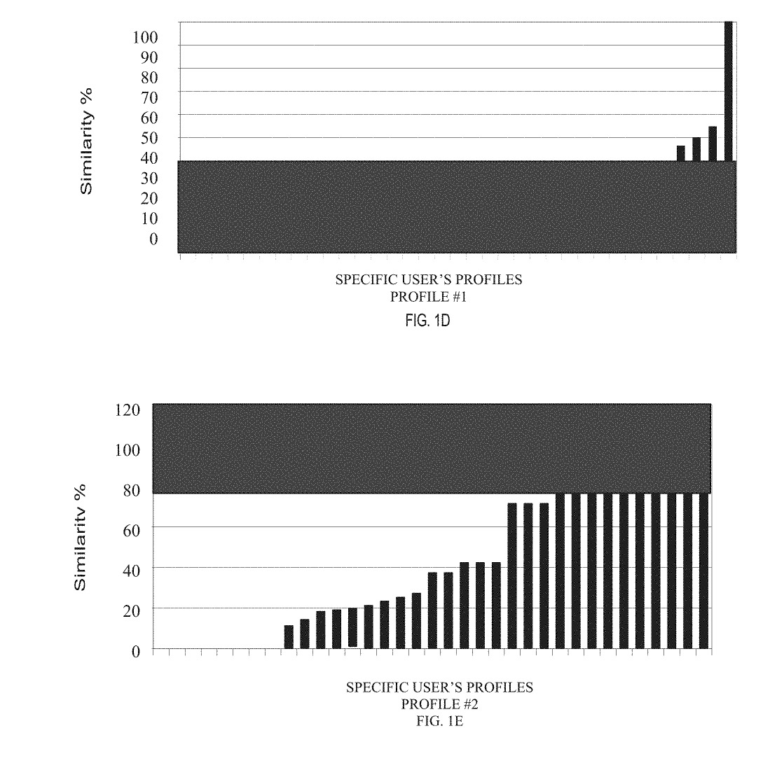

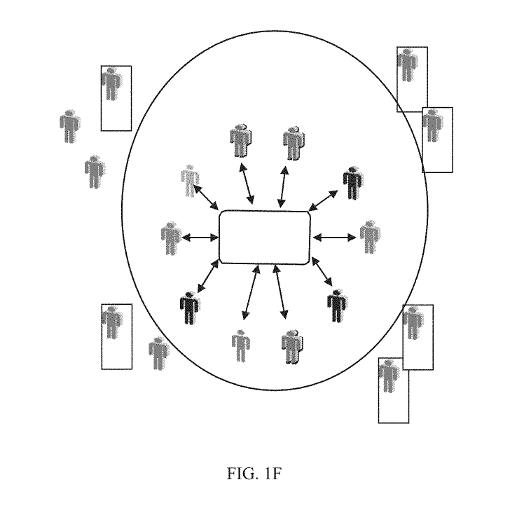

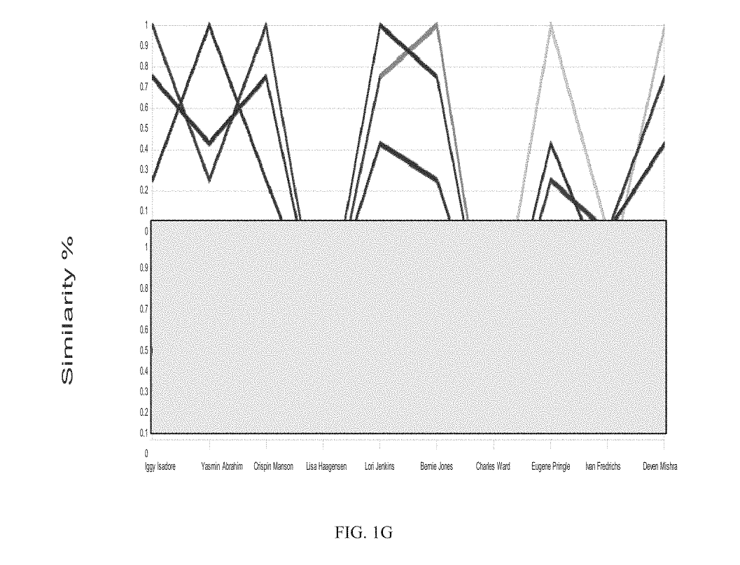

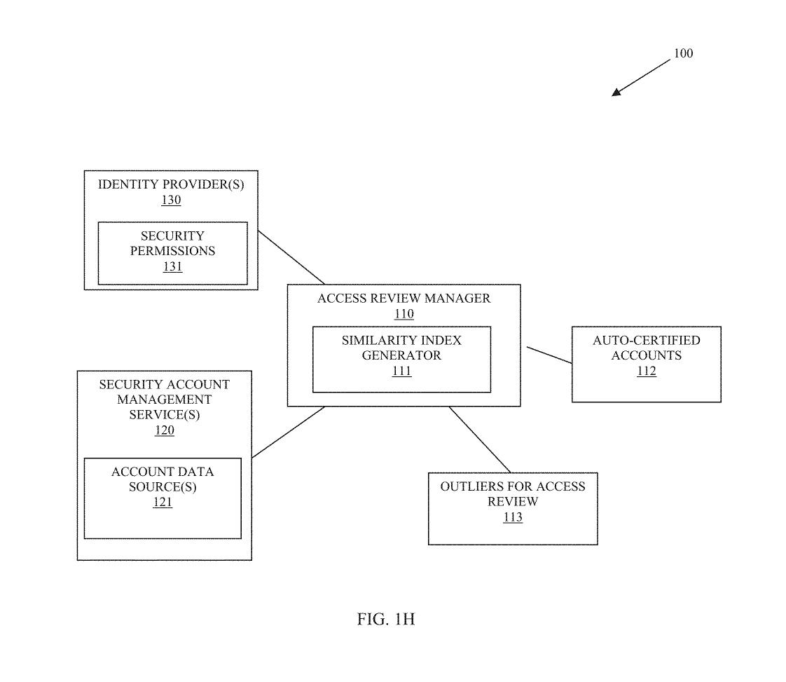

It is within this context that embodiments of the invention are now discussed within the context of the FIGS. 1A-1I and 2-4.

FIG. 1A is a diagram depicting a group of user accounts in a security system with noted visually distinctive similarity and differences between the accounts in terms of account attributes, according an example embodiment.

Each depicted use in the diagram includes a shade of grey. The shades of grey to black are intended to visually illustrate similarities or differences between use account attributes.

“Account attributes” includes security information and/or enterprise information assigned to a particular user. For example, account attributes can include access permissions with respect to resources (as defined above), such as: read (view only), no access, write access (viewing and modifying (delete, change, create)). The account attributes can also include enterprise information, such as: employee id, employee name, department, management level, job title, groups assigned to within the enterprise, roles within the enterprise, etc. The account attributes can be assigned in any enterprise combination for each given user account.

The circle that encircles three users is intended to illustrate similarities with those user accounts with one another as opposed to the remaining user accounts.

It is to be noted, throughout this discussion, that the term “user” can also include an automated resource, such as a service or a program because accounts can be established within an enterprise for automated programs as well, and such accounts can or may include their own account attributes. In this manner, the discussion provided herein can include automated accounts that are depicted as user accounts and that represent a valid user within the enterprise (an automated resource).

Moreover, the account attributes can be assembled from multiple different locations as needed, such that an employee identity can be used from the account attributes to obtain and acquire the security settings (permissions) as additional account attributes.

The security permissions can describe any of the following: 1) actions that the user can take within an application (type of resource, such as running a report, etc.); 2) items that the use may possess or may need to possess (such as an identity badge, etc.); and 3) resources that the user can access (such as a building, a server, a specific service, a specific directory, etc.).

The security permissions are granted either directly as the result of a specific user account attribute (such as department, job code, job title, etc.). The combination of all of a given user's security permissions determine his/her access.

Access reviews are processed to certify that users have only the level of access that they need to do their jobs within the enterprise.

For purposes of the discussion presented herein, the following assumptions are made: 1) the security system includes identities for principals (users or an automated service) that are collected from a variety of identity sources; 2) the security system includes security permissions for the collected identities collected from application sources; 3) the security permissions of an identity varies based on direct assignments, job codes, job titles, department assignments, etc.; and 4) identities within the security system have some security permissions in common based on either direct assignments, job codes, job titles, departments, etc.

The FIG. 1A illustrates a group of principal accounts (users or automated service accounts) in a sample set, where the that is some overlapping similarity in the account attributes (such as a similar job code, job description, and/or job title. The differences in the shades of grey and black for each principal account indicates the similarities of a principal's security permissions relative to the security permissions of the remaining principals in the sample set.

FIG. 1B is a diagram depicting a formula for determining similarities between account attributes of user accounts, according to an example embodiment.

The similarity in security permissions is calculated by processing statistical algorithms, such as the Jaccard Index or Sorensen Index.

The first formula depicted in the FIG. 1B is the Jaccard Index, which is also known as the Jaccard similarity coefficient. This is a statistic processed for comparing the similarity and diversity of given sample sets (depicted again as the first formula in the FIG. 1B).

The second formula depicted in the FIG. 1B is the Sorensen's Index, which is applied to presence/absence data. This can be viewed as a similarity measure over sets and will result in a number between 0 and 1.

For example, given a set A={1, 2, 3} and set B={2, 3, 4}, the intersection set |A Π B|={2, 3} and the union |A ∪ B|]={1, 2, 3, 4}. The Jaccard and Sorensen's index is calculated as:

J(A, B)=2/4=0.5 (Jaccard Index); and

S=2(2)/6=0.667.

The similarity index can be calculated on either: 1) a security permission profile and/or 2) a group of principals.

### Similarity Index Calculated for a Security Permission Profile

The security permission profile is a selected list of security permissions or security permissions derived from a given selected principal (user or automated service).

FIG. 1C is a diagram illustrating application of a given similarity profile for account attributes to identify similarity between principal accounts, according to an example embodiment.

A similarity index is generated for each principal in the sample set based on each principal's security permissions (account attributes) similarity to the security permission profile (selected or derived from a particular principal's account attributes). These similarity indexes show how similar each of the principals are with respect to the security permission profile, and the similarity indexes can be processed to bulk certify all principals within a selected similarity range (set as a predefined value by a reviewer). This reduces the number of principal accounts that require a manual detailed review, leaving only outliers for detailed review.

The FIG. 1C illustrates a sample set of principals where each principal's security permissions are processed to generate a similarity index value for each principal with respect to a given security permission profile. The circle illustrates three outliers requiring a more detailed review because those three have similarity index values that fall outside the predefined range, such that those three cannot be automatically certified during access review. Again, the varying shades of grey are intended to illustrate the similarities and differences between security permissions of the principals. Thus, in the present example, with 10 principal accounts used as a sample set and a selected security permissions profile (set of selected or derived security permissions) only three outliers require access review and the remaining seven can be bulk certified during the access review.

To further illustrate, consider a group of 25 principals, each principal assigned some subset of 45 different security permissions along with 2 permission profiles. The two permission profiles (in this example) are as follows.

| Permission Profile #1 | Permission Profile #2 |
|---|---|
| Income Statement View | Food Service Contractor |
| North Door | Direct Report |
| Cashflow Report View | Cashflow Report View |
| Purchase Limit Level 2 | North Door |
| Balance Sheet Report View | South Door |
| All Doors | Garage |
| Paystubs View Employee | |

The similarity indexes of the 25 example users (principals) using the Jaccard Index calculation (as identified in the FIG. 1B first formula) are calculated producing the a Jaccard Index value for each of the 25 users (note that a Jaccard Index value of 0 indicates that there are no permissions for such a user that is in common with the selected security permission profile (shown above) and a Jaccard Index value of 1 indicates there is an exact match for such a user with the selected security permission profile).

| | |
|---|---|
| Similarity Indexes - | Similarity Index - |
| Profile #1 | Profile #2 |

| | | | |
|---|---|---|---|
| Aaron Corry | 0 | Aaron Corry | 0 |
| Andrew Astin | 0 | Andrew Astin | 0 |
| Arturo Perez | 0 | Arturo Perez | 0 |
| Helen Winzen | 0 | Helen Winzen | 0 |
| Ken Nagai | 0 | Ken Nagai | 0 |
| Maria Miles | 0 | Maria Miles | 0 |
| Ratna Prasad | 0 | Ratna Prasad | 0 |
| Sarah Smith | 0 | Sarah Smith | 0 |
| Ivan Fredrichs | .083 | Henry Morgan | .11 |
| Charles Ward | .111 | Charles Ward | .14 |
| Dave Baum | .111 | Dave Baum | .18 |
| Bernie Jones | .214 | James Ross | .187 |
| Crispin Manson | .214 | Camille Pissaro | .187 |
| Iggy Isadore | .214 | Frank Drake | .21 |
| Devesh Mishra | .231 | Lisa Haagensen | .23 |
| Lori Jenkins | .231 | Armando Colaco | .25 |
| Leon Lavalette | .231 | Leon Lavalette | .27 |
| Bunny Jones | .25 | Gideon Laurent | .37 |
| Charles Ward | .25 | Ivan Fredrichs | .37 |
| Clara Ryan | .25 | Donald Volle | .42 |
| Elizabeth Navarro | .25 | Lena Springer | .42 |
| Simone DeMars | .25 | Lori Jenkins | .42 |
| Eugene Pringle | .273 | Eugene Pringle | .71 |
| Mryl Telemaque | .273 | Mryl Telemaque | .71 |
| Yasmin Abrahim | .273 | Yasmin Abrahim | .71 |
| Gideon Laurent | .30 | Bunny Jones | .85 |
| Camille Pissaro | .313 | Charles Ward | .85 |
| Donald Volle | .333 | Clara Ryan | .85 |
| Lena Springer | .333 | Elizabeth Navarro | .85 |
| Lori Jenkins | .333 | Simone DeMars | .85 |
| Henry Morgan | .375 | Bernie Jones | .87 |
| Frank Drake | .462 | Crispin Manson | .87 |
| James Ross | .50 | Iggy Isadore | .87 |
| Armando Colaco | .546 | Devesh Mishra | 1 |
| Lisa Haagensen | 1 | Lori Jenkins | 1 |

FIG. 1D is a diagram a graph that illustrates similarities and differences between user accounts using a similarity profile, according to an example embodiment.

The FIG. 1D presents a graphical illustration of the users' Jaccard Index values, where a reviewer as set the predefined range as those values that are less than 0.4 (40%) for profile #1. This leaves just 4 of the initial 25 users that require a more detailed review. The x-axis in the graph includes each of the individual users, such that (using the above table showing the calculated Jaccard Index values for each user): Frank Drake, James Ross, Armando Colaco, and Lisa Haagensen are readily identified as outliers based on the 40% or less selected range.

FIG. 1E is a diagram of a graph that illustrates similarities and differences between user accounts using a different similarity profile from that of the FIG. 1D, according to an example embodiment.

The FIG. 1E presents a graphical illustration of the users' Jaccard Index values, where a reviewer as set the predefined range as those values that are greater than 0.85 (85%) for profile #2. The above table showing the calculated Jaccard Index values for each user identifies those specific individuals requiring more detailed access review.

### Similarity Index Calculated for a Group of Principals/Users

Here, the similarity index is calculated for each user in the sample set to every other user in the group based on a specific account attribute (such as job code, job title, etc.).

FIG. 1F is a diagram depicting a group of user accounts in which each similar user in a group is compared against other users in the group based on a specific account attribute, according to an example embodiment.

A similarity index value is calculated for each user to every other user in the sample set. For example, the sample set may be all users with the tile or job code as manager. The resulting similarity matrix would indicate how similar a user is to every other user in the sample set.

The table that follows is an example of what a similarity matrix may look like for a sample set of eleven users that have the same job description along with a graph (the FIG. 1G) depicting the similarity of the users in the sample set to one another. Notice that Lisa Haagensen and Charles Ward are the least similar to other managers in the sample set. Based on these results, a reviewer may choose to bulk certify all uses except Lisa Haagensen, Charles Ward, and Ivan Fredichs, since these three have a similarity index value of less than 50% (predefined and selected range); these three would be said to be outliers in the sample set of eleven users.

| | Mryl | Iggy | Yasmin | Crispin | Lisa | Lori | Bernie | Charles | Eugene | Ivan | Deven |
|---|---|---|---|---|---|---|---|---|---|---|---|
| | Telemaque | Isadore | Abrahim | Manson | Haagensen | Jenkins | Jones | Ward | Pringle | Fredrichs | Mishra |
| Mryl | NA | 0.625 | 1 | 0.625 | 0.272 | 0.714 | 0.625 | 0.2 | 1 | 0.5 | 0.714 |
| Telemague | | | | | | | | | | | |
| Iggy | 0.625 | NA | 0.625 | 1 | 0.212 | 0.875 | 1 | 0.125 | 0.625 | 0.5 | 0.875 |
| Isadore | | | | | | | | | | | |
| Yasmin | 1 | 0.625 | NA | 0.625 | 0.272 | 0.714 | 0.625 | 0.2 | 1 | 0.5 | 0.714 |
| Abrahim | | | | | | | | | | | |
| Crispin | 0.625 | 1 | .625 | NA | 0.21 | 0.875 | 1 | 0.125 | 0.625 | 0.5 | 0.875 |
| Manson | | | | | | | | | | | |
| Lisa | 0.272 | 0.214 | 0.272 | 0.214 | NA | 0.23 | 0.214 | 0.111 | 0.272 | 0.083 | 0.23 |
| Haagensen | | | | | | | | | | | |
| Lori | 0.714 | 0.875 | 0.714 | 0.875 | 0.23 | NA | 0.875 | 0.142 | 0.714 | 0.375 | 1 |
| Jenkins | | | | | | | | | | | |
| Bernie | 0.625 | 1 | 0.625 | 1 | 0.214 | 0.875 | NA | 0.125 | 0.625 | 0.5 | 0.875 |
| Jones | | | | | | | | | | | |
| Charles | 0.2 | 0.125 | 0.2 | 0.125 | 0.111 | 0.142 | 0.125 | NA | 0.2 | 0.25 | 0.142 |
| Ward | | | | | | | | | | | |
| Eugene | 1 | 0.625 | 3 | 0.625 | 0.272 | 0.714 | 0.625 | 0.2 | NA | 0.5 | 0.714 |
| Pringle | | | | | | | | | | | |
| Ivan | 0.5 | 0.5 | 0.5 | 0.5 | 0.083 | 0.375 | 0.5 | 0.25 | 0.5 | NA | 0.375 |
| Fredrichs | | | | | | | | | | | |
| Deven | 0.714 | 0.875 | 0.714 | 0.875 | 0.23 | 1 | 0.875 | 0.142 | 0.714 | 0.375 | NA |
| Mishra | | | | | | | | | | | |

FIG. 1G is a diagram depicting a graphical illustration of the similarity matrix depicted in the above table, according to an example embodiment.

### Weighted Similarity Index Value

Many times within an organization there are certain security permissions that are considered more critical or higher risk than others. For example, a security permission granting someone access to view the company payroll or access to a room that holds critical computer systems is higher risk than granting someone access to the break room.

In some embodiments, to account for designated critical assets, a weighting factor can be processed within a statistical analysis. This allows permissions with a greater weight to have a greater impact on the calculated similarity index values.

Consider the original example where the Jaccard Index is for the set A={1, 2, 3} and the set B={2, 3, 4}.

J(A, B)=2/4=0.5 (calculated Jaccard Index value).

Now assume that {2} has a weight factor of 5 because it has a greater risk than the other set items. The new weighted sets become: A={1, 2, 2, 2, 2, 2, 3} and set B={2, 2, 2, 2, 2, 3, 4}. The new weighted intersection set |A Π B|={2, 2, 2, 2, 2, 3} and |A ∪ B|={1, 2, 2, 2, 2, 2, 3, 4}. For the weight factor consider each element {2} a derivative of the original so that the number of intersecting elements increases from 2 to 6 and the total number of elements increased from 4 to 8. The new weighted Jaccard Index value is calculated as follows:

J(A, B)=6/8=0.75.

So, weighting element {2} by a factor of 5 caused the Jaccard Index value for the Sets A and B to increase from 0.5 to 0.75 (50% increase).

It is now apparent how calculations of principal accounts (users or automated resources) can be made to generate similarity index values which when compared against a predefined range permits automatically certification of principal accounts during security access reviews. This can also be used for weighted calculation of similarity index values to account for sensitivity to certain organizational security permissions.

It is also to be noted that although the Jaccard Index value calculation was presented for purposes of illustration, other statistical algorithms can be processed as well without departing from the novel security access reviews presented herein and below, such as, but not limited to Sorensen Index, Dice's Coefficient, overlap coefficient, and the like.

FIG. 1H is a diagram depicting a system 100 for practicing security access review, according to an example embodiment. It is noted that the architectural processing environment 100 is presented as an illustrated embodiment and that other component definitions are envisioned without departing from the embodiments discussed herein. It is also to be noted that only those components necessary for comprehending the embodiments are presented, such that more or less components may be used without departing from the teachings presented herein.

The architectural processing environment 100 includes: an access review manager 110, security account management service(s) 120, and identity provider(s) 130.

It is noted that although the components are illustrated independently that this is done for illustration only. That is, the components can all reside and process on a same hardware device and same processing environments; or, the components can all reside and process on different hardware devices and different processing environments.

The access review manager 110 includes a backend interface for interacting with the identity provider(s) 130 and the security account management service(s) 120. The access review manager 110 also includes a user-facing interface for interacting and reporting results for automated actions or manual actions.

Initially, an access review is identified as being needed within an organization. This can be done manually or based on some security event detected within a security system of the organization that triggers an access review of principal (user or automated services) accounts (an Application Programming Interface (API) provides an automated detection of the security event and triggering by the access review manager of an access review).

The user-facing interface permits a security analyst to define a sample set of principal accounts. In an embodiment, the sample set may include all principal accounts. In an embodiment, the sample set is less than all principal accounts. In an embodiment, the sample set is a statistical sample of all user accounts. In an embodiment, the sample set is a statistical sample from a defined type of user account.

The access review manager 110 interacts with the security account management services 120 to access account data source(s) 121 and obtain account attributes for each principal account identified in the sample set. The account attributes can be any of the previously-noted attributes (in the FIGS, 1A-1G). The access review manager 110 also interacts with the identity providers 130 and obtains security permissions 131 for each principal account identified in the sample set. The security permissions can be any of the previously-noted security permissions (in the FIGS. 1A-1G).

In an embodiment, the user-facing interface of the access review manager 110 presents the account attributes and security permissions to the security analyst for the security analyst to select specific security permissions and account attributes that the user defines as a security profile for the sample set.

In an embodiment, the user-facing interface of the access review manager 110 presents pre-defined security profiles for selection by the security analyst as the security profile.

In an embodiment, the user-facing interface of the access review manager 110 allows the security analyst to select a designated principal account from which the security profile is derived based on that principal's security permissions.

Once the security profile is defined (based on the security analyst's actions with the user-facing interface of the access review manager 110), the access review manager 110 initiates the similarity index generator 111.

The similarity index generator 111 produces a similarity index value for each principal account in the sample set. In an embodiment, the similarity index generator 111 processes a Jaccard Index algorithm to produce the similarity index values (as shown in FIG. 1B and discussed above). In an embodiment, the similarity index generator 111 processes a Sorensen's Index algorithm to produce the similarity index values.

In an embodiment, the user-facing interface of the access review manager 110 permits the security analyst to select the statistical algorithm that the similarity index generator 110 processes against the principal accounts for generating the similarity index values.

The user-facing interface of the access review manager 110 also permits the security analyst to define a threshold range or select a predefined threshold range from a list of ranges. The security analyst can also define whether similarity index values within the range are to be auto-certified accounts 112 for the access review or outliers 113 for more detailed, and perhaps, manual review. That is, an outlier may be defined through the user-facing interface by the security analyst as falling within the threshold range or falling outside the threshold range.

The access review manager 110 then presents the similarity indexes (generated by the similarity index generator 111) in a variety of manners, which the security analyst can customize. Some of these were presented above as tables, graphs, etc. Listings or reports can be automatically generated as well as auto-certified accounts 112 and outliers for access review 113.

Moreover, the user-facing interface permits the security analyst to request that the similarity index values be generated by the similarity index generator 111 for each principal within a defined group of principals based on one or more specific attributes for the group (discussed above).

Still further, the similarity index generator 111 can be configured through the user-facing interface by the security analyst to process weighted similarity index values (as discussed above).

In an embodiment, the access review manager 110 and the similarity index generator 111 process automatically. For example, when a security event or a scheduled time is reached, a sample set is statistically generated and a predefined security permissions profile obtained. The similarity index values for the sample set are then compared against a pre-defined range and the sample set is separated into the auto-certified accounts 112 and the outliers 113. The auto-certified accounts 112 can be automatically sent through an API to the organization's security system and principal accounts associated therewith flagged as having been certified. Concurrently, the outliers 113 are noted to the security system, which may be configured to temporarily freeze access to the outliers 113 and report the outliers to security personnel for manual review. That is, the entire access review can be done in an automated fashion or it can be done interactively with input from the security analyst (as discussed above).

Moreover, because access reviews can be processor-intensive, the approaches discussed herein improves processor throughput and reduces the time it takes for performing access reviews for compliance and internal security. This is achieved because outlier identification from the sample set reduces substantially the number of accounts that have to be reviewed. The approaches here are also configurable and customizable based on the needs of an organization's security system and compliance issues.

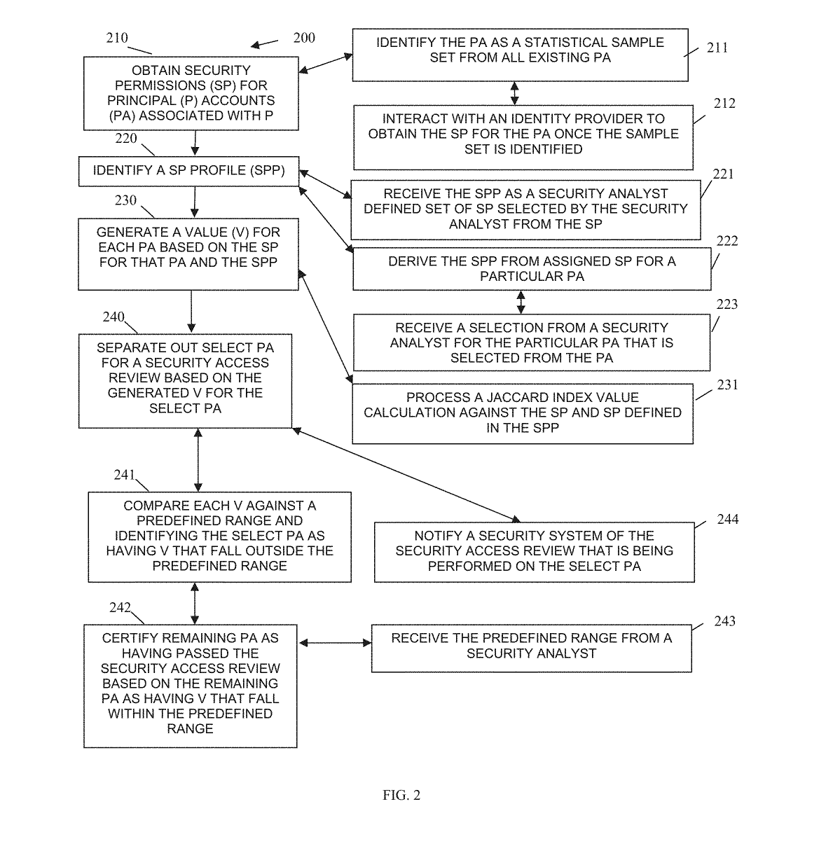

The embodiments discussed above and other embodiments are now discussed with reference to the FIGS. 2-4.

FIG. 2 is a diagram of a method 200 for processing security access reviews, according to an example embodiment. The method 200 is implemented as one or more software modules (herein after referred to as an “access review manager”). The access review manager is represented as executable instructions that are implemented, programmed, and resides within memory and/or a non-transitory machine-readable storage media; the executable instructions execute on one or more hardware processors of one or more network devices and have access to one or more network connections associated with one or more networks. The networks may be wired, wireless, or a combination of wired and wireless.

In an embodiment, access review manager performs the processing discussed above with reference to the FIGS. 1A-1H. In an embodiment, the access review manager is the access review manager 110 and the similarity index generator 111 of the FIG. 1H.

At 210, the access review manager obtains security permissions for principal accounts associated with principals. In an embodiment, the principals are end-users. In an embodiment, the principals are automated services. In an embodiment, the principals are a combination of end-users and automated services. The accounts are for access to an organization's resources (physical equipment, hardware and software, data storage, network devices, etc.).

According to an embodiment, at 211, the access review manager identifies the principal accounts as a statistical sample set from all existing principal accounts within the organization.

In an embodiment of 211 and at 212, the access review manager interacts with at least one identity provider to obtain the security permissions for the principal accounts once the sample set is identified. In an embodiment, the identity provider is the identity provider(s) 130.

At 220, the access review manager identifies a security permissions profile.

In an embodiment, at 221 the access review manager receives the security permissions profile as a security analyst-defined set of security permissions selected by the security analysts from the security permissions associated with the principal accounts.

In an embodiment, at 222, the access review manager derives the security permissions profile from assigned security permissions for a particular principal account.

In an embodiment of 222 and at 223, the access review manager receives a selection from a security analyst for the particular principal account that is selected from the principal accounts by the security analyst.

At 230, the access review manager generates a value for each principal account based on the security permissions of each principal account and the security permissions profile. That is, a similarity index value is calculated for and assigned to each principal account to identify the similarity of each principal account to the security permissions profile. This can be done in any of the manners discussed above with the FIGS. 1A-1H.

According to an embodiment, at 231, the access review manager processes a Jaccard Index value calculation against the security permissions for each principal account and the security permissions defined in the security permissions profile.

In embodiment of 231, the access review manager processes a weighted Jaccard Index value calculation that weights one or more specific security permissions. This was discussed above with the FIGS. 1G-1H.

At 240, the access review manager separates our select principal accounts for security access review based on the generated similarity index values for the principal accounts.

According to an embodiment, at 241, the access review manager compares each similarity index value against a predefined range, and the access review manager identifies the select principal accounts for the access review as having similarity index values that fall outside the predefined range.

In an embodiment of 241 and at 242, the access review manager certifies remaining principal accounts as having passed the security access review based on the remaining principal accounts as having similarity index values that fall within the predefined range.

In an embodiment of 242 and at 243, the access review manager receives the predefined range from a security analyst.

In an embodiment, at 244, the access review manager notifies a security system service of the security access review that is being performed on the selected principal accounts. The security system service may elect to temporarily suspend access to these accounts being reviewed; although this does not have to be the case.

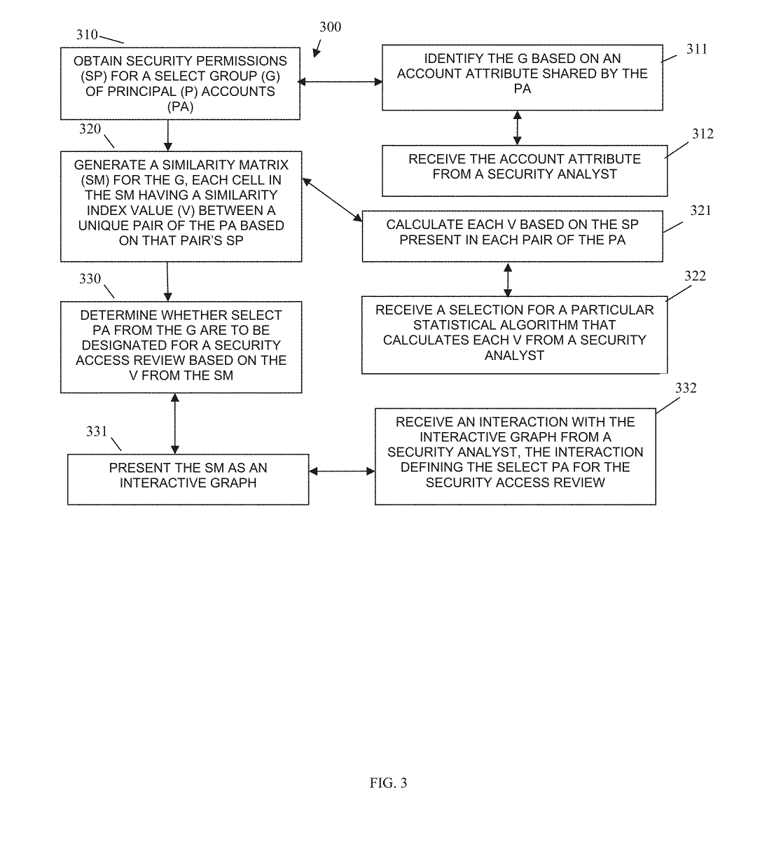

The processing of the access review manager reflects the processing discussed above for determining similarity based on a security permissions profile. The FIG. 3 is now discussed for the processing discussed above for determining similarities between pairs of principal accounts through a similarity matrix.

FIG. 3 is a diagram of another method 300 for processing access reviews, according to an example embodiment. The method 300 is implemented as one or more software module(s) (herein after referred to as an “security reviewer”) on one or more hardware devices. The security reviewer is represented as executable instructions that are implemented, programmed, and resides within memory and/or a non-transitory machine-readable storage medium; the executable instructions execute on one or more hardware processors of the one or more hardware devices and have access to one or more network connections associated with one or more networks. The networks may be wired, wireless, or a combination of wired and wireless.

In an embodiment, the security reviewer performs any of the processing discussed above in the FIGS. 1A-1H. In an embodiment, the security reviewer is the access review manager 110 of the FIG. 1H.

In an embodiment, the security reviewer is the method 200 of the FIG. 2.

At 310, the security reviewer obtains security permissions for a select group of principal accounts associated with principals. Again, the principals can be end-users, automated services, or a combination thereof. The accounts associated with access to an organization resources.

According to an embodiment, at 311, the security reviewer identifies the group based on at least one common attribute shared by the principal account, such as job title, job code, job description, etc.

In an embodiment of 311 and at 312, the security reviewer receives the account attribute from a security analyst.

At 320, the security reviewer generates a similarity matrix for the group. Each cell in the similarity matrix having a similarity index value representing a similarity relationship value between unique pairs of the principal accounts based on that pair's security permissions. That is, each principal account is assigned similarity values for each remaining account and the relationship of the entire group is depicted in the similarity matrix. This was also discussed and presented above with the discussion of the FIGS. 1F-1G.

In an embodiment, at 321, the security reviewer calculates each value based on the security permissions present in each pair of the principal accounts.

In an embodiment of 321 and at 322, the security reviewer receives a selection for a particular statistical algorithm that calculates each value. The selection received from a security analyst. The particular statistical algorithm can be any of the ones mentioned above with the FIGS. 1A-1H, such as Jaccard, Sorensen, etc.

In an embodiment, each similarity index value is produced using a weighting factor, such as what was discussed above with the FIGS. 1G-1H. The weighting factor weights one or more of the security permissions when generating the similarity index values for each unique pair of principal accounts.

At 330, the security reviewer determines whether select principal accounts from the group are to be designated for security access review based on the similarity index values that populate the similarity matrix.

In an embodiment, at 331, the security reviewer presents the similarity matrix as an interactive graph for interaction by a security analyst, such as the interactive graph presented in the FIG. 1G above.

In an embodiment of 331 and at 332, the security reviewer receives an interaction with the interactive graph from the security analyst. The interaction defining the select principal accounts for the security access review and/or for defining other principal accounts for being certified as having passed the security access review.

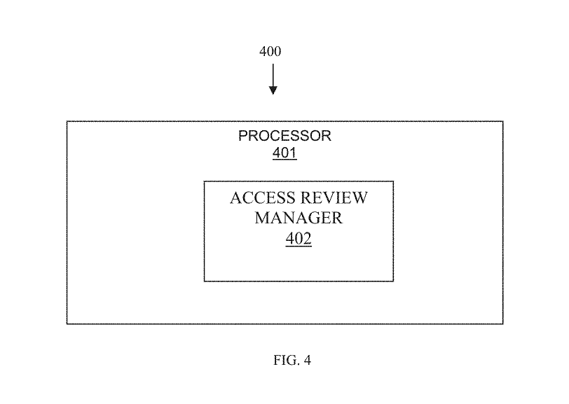

FIG. 4 is a diagram of another security access review system 400, according to an embodiment. Various components of the security access review system 400 are software module(s) represented as executable instructions, which are programed and/or reside within memory and/or non-transitory computer-readable storage media for execution by one or more hardware devices. The components and the hardware devices have access to one or more network connections over one or more networks, which are wired, wireless, or a combination of wired and wireless.

In an embodiment, the security access review system 400 implements, inter alia, the processing depicted in the FIGS. 1A-1H and the FIGS. 2-3. Accordingly, embodiments discussed above with respect to the FIGS. presented herein and above are incorporated by reference herein with the discussion of the security access review system 400.

The multi-factor authentication system 400 includes a processor 401 and an access review manager 402.

In an embodiment, the processor 401 is part of a server.

In an embodiment, the processor 401 is part of a cloud processing environment.

The access review manager 402 is configured and adapted to: 1) execute on the processor 401, 2) determine similarities between security permissions of principal accounts associated with principals, and 3) identifies select principal accounts for a security access review.

In an embodiment, the access review manager 402 is further configured, in 2), to determine the similarities based on: a) a security permissions profile (as discussed in the method 200 above), or b) unique similarities between pairs of the principal accounts (as discussed in the method 300 above).

In an embodiment, the similarities are produced as similarity index values using any of the above-mentioned statistical algorithms. In an embodiment, the similarities are produces based on weighted security permissions as discussed above with the FIGS. 1G-1H.

In an embodiment, the access review manager 402 is one or more of: the access review manager 110, the processing discussed in the FIGS. 1A-1G, the processing discussed as the method 200 of the FIG. 2, and/or the processing discussed as the method 300 of the FIG. 3.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method, comprising:
obtaining security permissions for principal accounts associated with principals;
identifying a security permissions profile;
generating a value for each principal account based on the security permissions for that principal account and the security permission profile; and
separating out select principal accounts for a security access review based on the generated values for the select principal accounts.

2. The method of claim 1, wherein obtaining further includes identifying the principal accounts as a statistical sample set from all existing principal accounts.

3. The method of claim 2, wherein identifying further includes interacting with at least one identity provider to obtain the security permissions for the principal accounts once the sample set is identified.

4. The method of claim 1, wherein identifying further includes receiving the security permissions profile as a security analyst defined set of security permissions selected by the security analyst from the security permissions.

5. The method of claim 1, wherein identifying further includes deriving the security permissions profile from assigned security permissions for a particular principal account.

6. The method of claim 5, wherein deriving further includes receiving a selection from a security analyst for the particular principal account that is selected from the principal accounts.

7. The method of claim 1, wherein generating further includes processing a Jaccard Index value calculation against the security permissions and security permissions defined in the security permissions profile.

8. The method of claim 1, wherein separating further includes comparing each value against a predefined range and identifying the select principal accounts as having values that fall outside the predefined range.

9. The method of claim 8, wherein comparing further includes certifying remaining principal accounts as having passed the security access review based on the remaining principal accounts as having values that fall within the predefined range.

10. The method of claim 9, wherein separating further includes receiving the predefined range from a security analyst.

11. The method of claim 1, wherein separating further includes notifying a security system of the security access review that is being performed on the select principal accounts.

12. A method, comprising:
obtaining security permissions for a select group of principal accounts;
generating a similarity matrix for the select group of principal accounts, each cell in the similarity matrix having a similarity index value between a unique pair of the principal accounts based on that pair's security permissions; and
determining whether select principal accounts from the group are to be designated for a security access review based on the similarity index values from the similarity matrix.

13. The method of claim 12, wherein obtaining further includes identifying the select group based on an account attribute shared by the principal accounts.

14. The method of claim 13, wherein identifying further includes receiving the account attribute from a security analyst.

15. The method of claim 12, wherein generating further includes calculating each similarity index value based on the security permissions present in each pair of the principal accounts.

16. The method of claim 15, wherein calculating further includes receiving a selection for a particular statistical algorithm that calculates each similarity index value from a security analyst.

17. The method of claim 16, wherein determining further includes presenting the similarity matrix as an interactive graph.

18. The method of claim 17, wherein presenting further includes receiving an interaction with the interactive graph from a security analyst, the interaction defining the select principal accounts for the security access review.

19. A system, comprising:
a processor;
an access review manager configured and adapted to: i) execute on the processor, ii) determine similarities between security permissions of principal accounts associated with principals, and iii) identify select principal accounts for a security access review.

20. The system of claim 19, wherein the access review manager is further configured, in ii), to: determine the similarities based on: a) a security permissions profile or b) unique similarities between pairs of the principal accounts.
